(19) United States
(12) Patent Application Publication
(10) Pub. No.: US 2009/0147681 A1
(43) Pub. Date: Jun. 11, 2009

(54) METHOD AND APPARATUS OF DOWNSTREAM SERVICE FLOW CONTROL IN HFC NETWORKS

(76) Inventors: Ho-Sook LEE, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/187,544

(22) Filed: Aug. 7, 2008

(30) Foreign Application Priority Data
Dec. 5, 2007 (KR) 10-2007-0125470

(51) Int. Cl. H04L 12/56

(52) U.S. Cl. 370/235

(57) ABSTRACT

A method and apparatus of controlling a downstream service flow is provided. A method of controlling a downstream service flow, the method including: receiving a control request with respect to a service flow; generating classifier information for identifying a Quality of Service (QoS) classification standard of the service flow for which a generation request is performed, and registering the generated classifier information in a table when the control request is the generation request for the service flow; registering a pattern mask corresponding to the classifier information in the table; and composing the table for searching for downstream service flow information of a downstream input packet using the classifier information and the pattern mask.

### CROSS-REFERENCE TO RELATED APPLICATION

This application claims priority from Korean Patent Application No. 10-2007-0125470, filed on Dec. 5, 2007, in the Korean Intellectual Property Office, the entire disclosure of which is incorporated herein by reference.

### BACKGROUND OF THE INVENTION

1. Field of the Invention

The present invention relates to downstream service flow processing in a Hybrid Fiber Coax (HFC) network, and more particularly, to a method and apparatus of controlling a downstream service flow coming into a Cable Modem Termination System (CMTS) located in a headend from a network service interface.

This work was supported by the IT R&D program of MIC/IITA [2006-S-019-02, The Development of Digital Cable Transmission and Receive System for 1 Gbps Downstream].

2. Description of Related Art

A Hybrid Fiber Coax (HFC) network is a network including an optical fiber and a coaxial cable, and is a broadband transmission network to transmit a data signal using the optical fiber to a broadcasting station and an Optical Network Unit (ONU), and using the coaxial cable from the ONU to subscribers.

A downstream data packet inputted using a network interface in a cable network following Data Over Cable Service Interface Specifications (DOCSIS) must be transmitted to a channel for reception of a corresponding cable modem (CM) in order to transmit the downstream data packet to a specific CM.

A single channel or, when channel bonding is supported, a plurality of channels may be used for transmission to the corresponding CM″?. Downstream packets are classified into service flows in accordance with each Quality of Service (QoS) and are scheduled to be transmitted via the channel for transmission of the CM.

Accordingly, a Cable Modem Termination System (CMTS) must allocate and classify the service flows based on the QoS requested from the CM.

The CMTS needs a method and apparatus of controlling a service flow to generate/delete/change the service flows for transmitting a downstream packet.

### SUMMARY OF THE INVENTION

An aspect of the present invention provides a method of controlling a downstream service flow for a cable modem (CM) which can generate/delete/change the downstream service flow requested from the CM.

Another aspect of the present invention also provides a method of controlling a downstream service flow which can classify classification information about the downstream service flow by a type and a Quality of Service (QoS), and generate a pattern mask applied to an input packet.

Another aspect of the present invention also provides a method of controlling a downstream service flow which can generate a matching pattern for classifying the downstream service flow based on classification information about the downstream service flow and record the matching pattern in a service flow information table.

Another aspect of the present invention also provides a method of controlling a downstream service flow which can assign a priority classified by a protocol layer to a classification standard when setting a classifier of a service flow.

Another aspect of the present invention also provides a method of controlling a downstream service flow which can assign a priority based on an inclusion relation classified by a classifier so that the classifier may not be overlapped, and set the classifier.

According to an aspect of the present invention, there is provided a method of controlling a downstream service flow for a CM, the method including: receiving a control request with respect to a service flow; generating classifier information for identifying a QoS classification standard of the service flow for which a generation request is performed, and registering the generated classifier information in a table when the control request is the generation request for the service flow; registering a pattern mask corresponding to the classifier information in the table; and composing the table for searching for downstream service flow information of a downstream input packet using the classifier information and the pattern mask.

According to another aspect of the present invention, there is provided an apparatus for controlling a downstream service flow for a CM, the apparatus including: a service flow controller to control a service flow based on a control request with respect to the service flow; a classifier table storage unit to register, via control of the service flow controller, classifier information for identifying a QoS classification standard of the service flow requested; a classifier pattern table storage unit to store a pattern mask corresponding to the classifier information; and a downstream service flow table storage unit to search for service flow information using the classifier information and the pattern mask.

### DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates a downstream service flow processing unit of a Cable Modem Termination System (CMTS) according to an exemplary embodiment of the present invention;

FIG. 2 illustrates an apparatus for controlling a service flow according to an exemplary embodiment of the present invention;

FIG. 3A illustrates an information table according to an exemplary embodiment of the present invention;

FIG. 3B illustrates classifier information classified by a cable modem (CM) according to an exemplary embodiment of the present invention;

FIG. 3C illustrates a matching pattern for classifying a service flow according to an exemplary embodiment of the present invention;

FIG. 4 illustrates example of a Quality of Service (QoS) classification standard;

FIG. 5 is a flowchart illustrating a method of controlling a downstream service flow according to an exemplary embodiment of the present invention; and

FIG. 6 is a flowchart illustrating a method of determining a priority of classifier information according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

The following detailed description is provided to assist the reader in gaining a comprehensive understanding of the media, apparatuses, methods and/or systems described herein. Accordingly, various changes, modifications, and equivalents of the systems, methods, apparatuses and/or media described herein will be suggested to those of ordinary skill in the art. Also, description of well-known functions and constructions are omitted to increase clarity and conciseness.

A Cable Modem Termination System (CMTS) needs a service flow controller to generate/delete/change service flows for transmitting a downstream packet. A downstream service flow controller must generate classifier information and a matching pattern required for classifying a service flow so that downstream packets may be classified into corresponding services flow when the downstream packets are inputted into a Media Access Control (MAC) layer of a headend cable modem (CM), and must record the classifier information and the matching pattern in an information table for classifying a downstream packet of a CMTS MAC layer.

When generating the service flow and composing classification information, the downstream service flow controller must reflect standards with respect to classification of an Internet Protocol version 4 (IPv4) packet defined by Data Over Cable Service Interface Specifications (DOCSIS), classification of a Transmission Control Protocol/User Datagram Protocol (TCP/UDP) packet, classification of an Ethernet Logical Link Control (LLC) packet, classification of an Institute of Electrical and Electronics Engineers (IEEE) 802.1P/Q packet, classification of an IPv6 packet, and classification of a developer's unique packet, based on Quality of Service (QoS) information of the service flow requested by a cable modem (CM).

Since a single CM may support a plurality of service flows, at least one service flow and classification standard may be set for each CM. Accordingly, the downstream service flow controller must set a priority among packet classification standards based on a QoS classified by the service flow, and set the priority based on an inclusion relation of a classification range when overlapping in the classification standards exists.

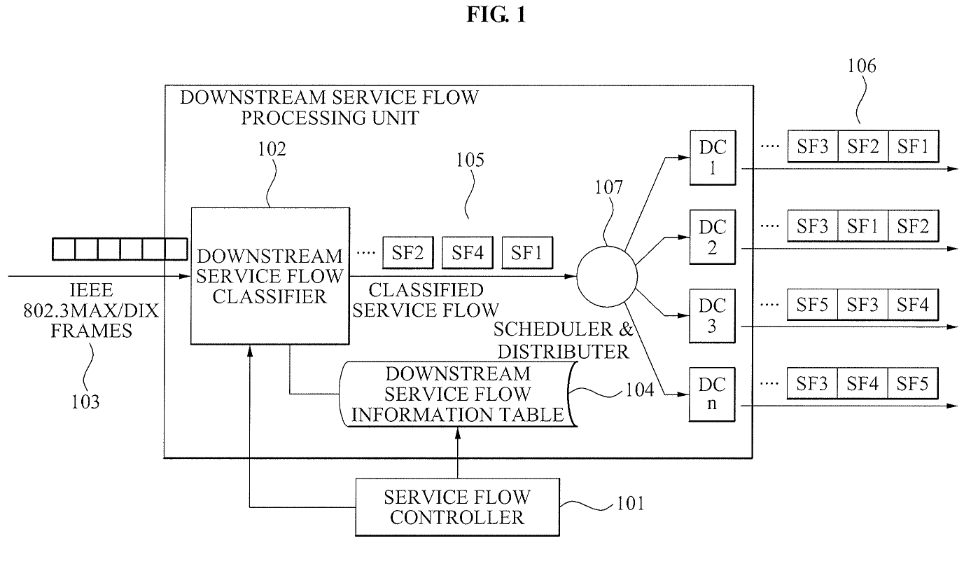

FIG. 1 illustrates a downstream service flow processing unit of a CMTS according to an exemplary embodiment of the present invention.

Referring to FIG. 1, a CMTS MAC layer includes a downstream service flow classifier 102, a scheduler and distributer 107, and a service flow controller 101.

The downstream service flow classifier 102 classifies downstream data packets 103 of an IEEE 802.3 MAC/DEC-Intel-Xerox (DIX) form coming from a DOCSIS-based Hybrid Fiber Coax (HFC) network to a CMTS by a service flow unit.

The downstream service flow classifier 102 classifies a service flow 105 by which a packet is served, based on a QoS of each packet referring to a downstream service flow information table 104.

The scheduler and distributer 107 includes a realignment device (not shown) to realign downstream packets classified by a downstream service for supporting a channel bonding function, and a scheduling device (not shown) to perform scheduling based on a transmission policy classified by the service flow. Here, service flow information is classified in the downstream packets.

The downstream packets in which the service flow information is classified are distributed (106) to a downstream channel to be transmitted based on the scheduling performed by the scheduling device, and are transmitted to a CM.

The service flow controller 101 generates service flows to classify the downstream packets, which come into a headend, into the service flows in a CMTS MAC layer, sets classification-related information about the generated service flows, sets a priority among classifiers, transmits service flow-related information to an information table of a MAC layer, and supports that the service flow-related information may be used for a classification process of the downstream packets.

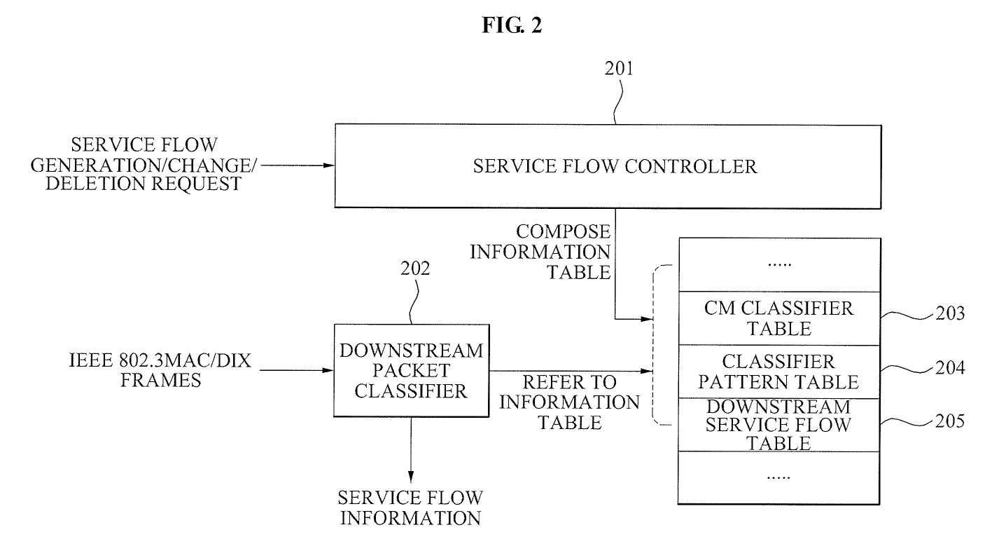

FIG. 2 illustrates an apparatus for controlling a service flow according to an exemplary embodiment of the present invention.

Referring to FIG. 2, the apparatus for controlling the service flow includes a service flow controller 201 to control the service flow based on a control request with respect to the service flow, a CM classifier table storage unit 203 to register, via control of the service flow controller 201, classifier information for identifying a QoS classification standard of the service flow requested, a classifier pattern table storage unit 204 to store a pattern mask corresponding to the classifier information, and a downstream service flow table storage unit 205 to search for service flow information using the classifier information and the pattern mask.

In following descriptions, the CM classifier table storage unit 203, the classifier pattern table storage unit 204, and the downstream service flow table storage unit 205 are respectively used as the same meaning as a CM classifier table, a classifier pattern table, and a downstream service flow table.

When a service flow generation/deletion/change request transmitted from a CM to a CMTS is received, the service flow controller 201 defines the service flow.

The service flow controller 201 defines a classifier referred by a downstream packet classifier 202 of a CMTS MAC layer for packet classification, sets the classifier information classified by the CM, and stores the classifier information in the CM classifier table 203.

The service flow controller 201 composes a classifier pattern to be applied being classified by the classifier, and records the classifier pattern in the classifier pattern table 204.

The service flow controller 201 records information about the defined service flow and a matching string to search for the information in the downstream service flow table 205, and enables the information and the matching string to be used for a packet classification process of the downstream packet classifier 202.

A Content Addressable Memory (CAM) scheme, a Ternary Content Addressable Memory (TCAM) scheme for enabling a search of a database or contents, and the like may be applied to each information table 203, 204, and 205.

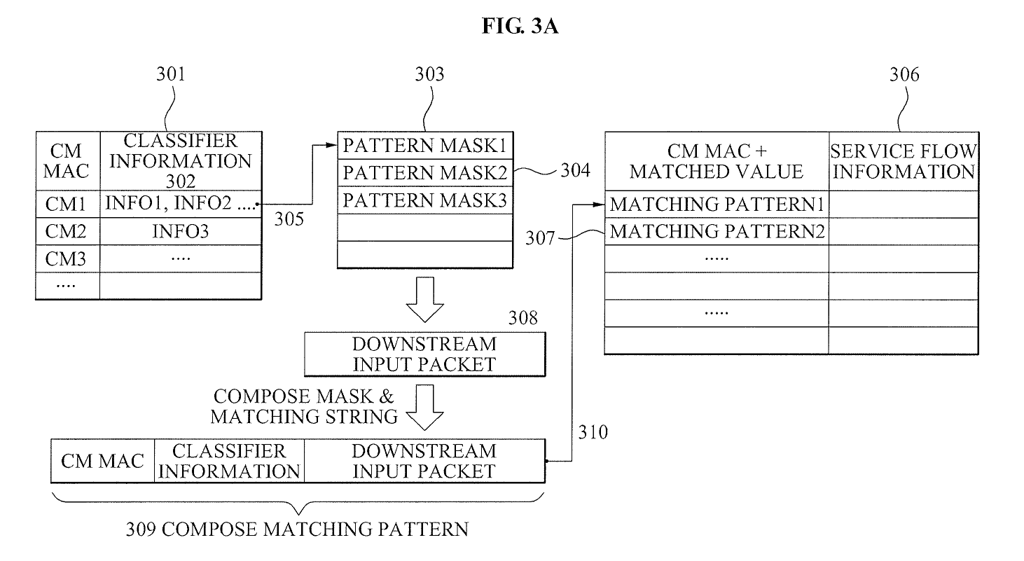

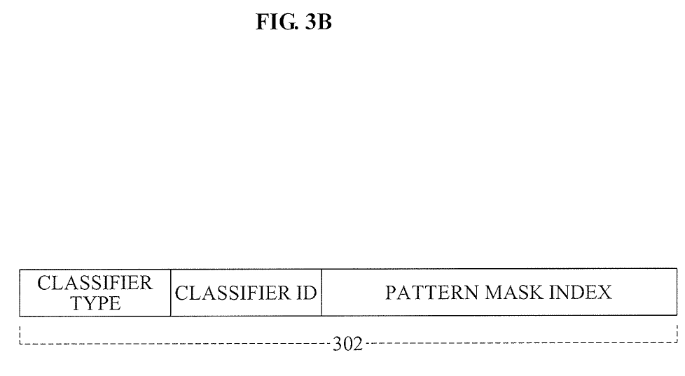

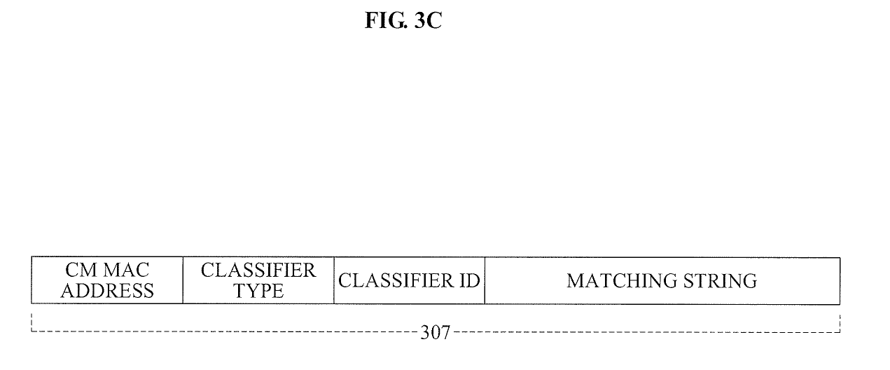

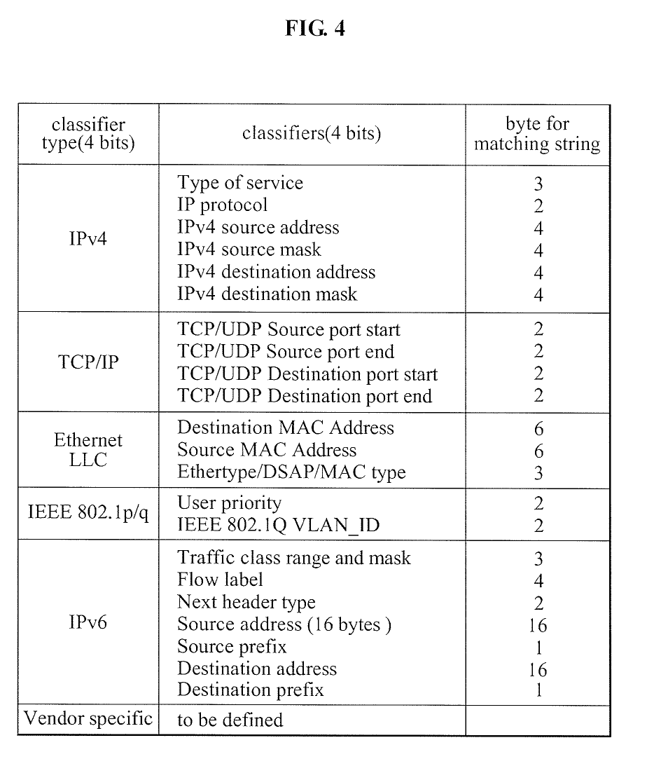

FIG. 3A illustrates an information table according to an exemplary embodiment of the present invention, FIG. 3B illustrates classifier information classified by a CM according to an exemplary embodiment of the present invention, and FIG. 3C illustrates a matching pattern for classifying a service flow according to an exemplary embodiment of the present invention. Also, FIG. 4 illustrates example of a QoS classification standard.

Referring to FIG. 3A, a CM classifier table 301 is a table to record classifier information 302 about downstream service flows defined being classified by a CM.

Since a single CM may generate at least one service flow, the classifier table records information about classifiers defined being classified by the CM based on a priority. A classifier having a high priority is stored in a first-retrieved location.

As illustrated in FIG. 3B, the classifier information includes a classifier type with respect to a 4-byte service flow, a 4-byte classifier identifier, and an index field with respect to a pattern mask applied to a corresponding classifier.

The classifier type and classifier identifier information are used for identifying a QoS classification standard illustrated in FIG. 4.

A pattern mask index field is used for a reference field to search for a pattern mask for corresponding QoS classification.

Referring to FIG. 3A, a classifier pattern table 303 is used for appointing a specific header field on a data packet or a location of the data packet necessary for service flow classification from an inputted packet.

The classifier pattern table 303 is used for composing a matching string for classification from the input packet when classifying the service flow in a CMTS MAC layer.

The classifier pattern table 303 includes bit mask information 304 of setting a corresponding QoS indication location of an input header as ‘1’ based on a QoS standard with respect to classifiers illustrated in FIG. 4.

The bit mask information 304 is indicated as a bit character string as long as a length of a protocol header applied from an upper bit of the input packet.

According to an exemplary embodiment of the present invention, mapping of all entries of the classifier pattern table 303 with the classifier information recorded in the CM classifier table is mapped one-to-one via a link 305.

Referring to FIG. 3A, a downstream service flow table 306 is an information table to search for downstream service flow information via a link 310 using, as a search word, a matching pattern 309 extracted by CM classifier information and a classifier pattern mask with respect to the packet inputted in the CMTS MAC layer.

Referring to FIG. 3C, a matching pattern 307 for service flow search includes an Ethernet MAC address of a CM, classifier type and identifier information, and a matching string used for a classification standard.

A CMTS MAC layer includes the classifier type and identifier information acquired from a CM classifier table such as the matching pattern 307 with respect to the CM to which a packet is transmitted when a downstream packet is inputted, and pattern information extracted from a packet 308 inputted using a pattern mask extracted from the classifier pattern table 303 as the matching string.

The matching pattern 307 is used for a search word for service flow information search.

Information about the retrieved downstream service flow may be accessed by directly using a value or an indirect address scheme.

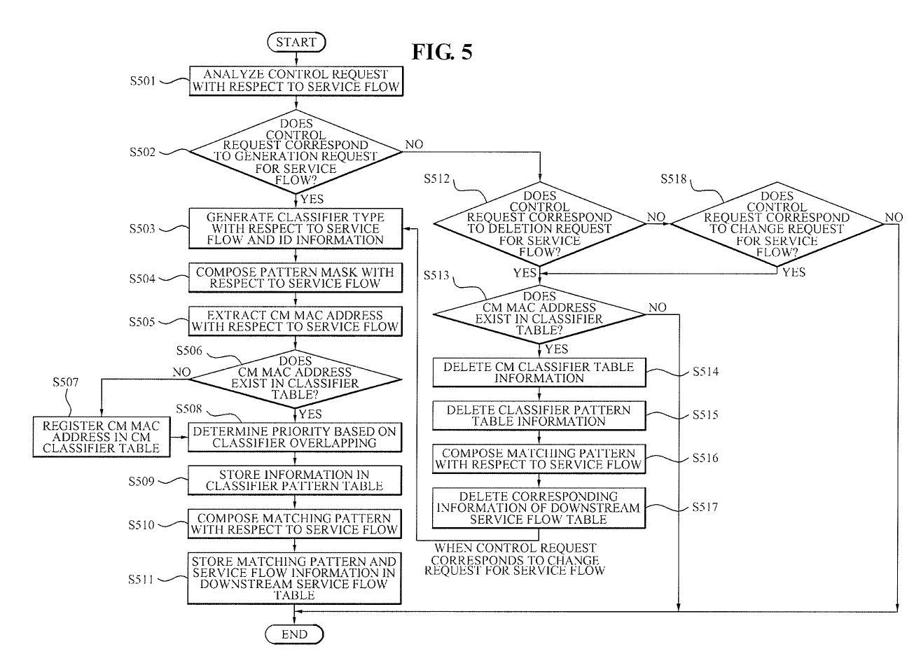

FIG. 5 is a flowchart illustrating a method of controlling a downstream service flow according to an exemplary embodiment of the present invention.

Referring to FIG. 5, the method of controlling the downstream service flow includes receiving a control request with respect to a service flow in operation S501, generating classifier information for identifying a QoS classification standard of the service flow for which a generation request is performed, and registering the generated classifier information in a table when the control request is the generation request for the service flow in operations S503, S505, S507, and S508, registering a pattern mask corresponding to the classifier information in the table in operations S504 and S509, and composing the table for searching for downstream service flow information of a downstream input packet using the classifier information and the pattern mask in operations S510 and S511.

In operation S501, when the control request with respect to the service flow is received from a CM, the service flow controller 201 of the CMTS analyzes control information with respect to the service flow. In operation S502, the service flow controller 201 determines whether the control request corresponds to the generation request for the service flow.

In operations S503 through S505, when the control request corresponds to the generation request for the service flow, the service flow controller 201 generates a classifier type with respect to the requested service flow and Identification (ID) information, and composes a pattern mask with respect to a corresponding classifier and CM MAC information.

In operation S506, the service flow controller 201 searches for a CM classifier table and determines whether the requested CM is a registered CM. In operation S507, the service flow controller 201 registers a CM MAC address with respect to an unregistered CM in the CM classifier table.

In operation S508, when the CM is already registered in the CM classifier table, the service flow controller 201 sets a priority based on overlapping with respect to the classifier information composed in operations S503 through S505 and the registered classifier information. The service flow controller 201 determines a storage location of the CM classifier table.

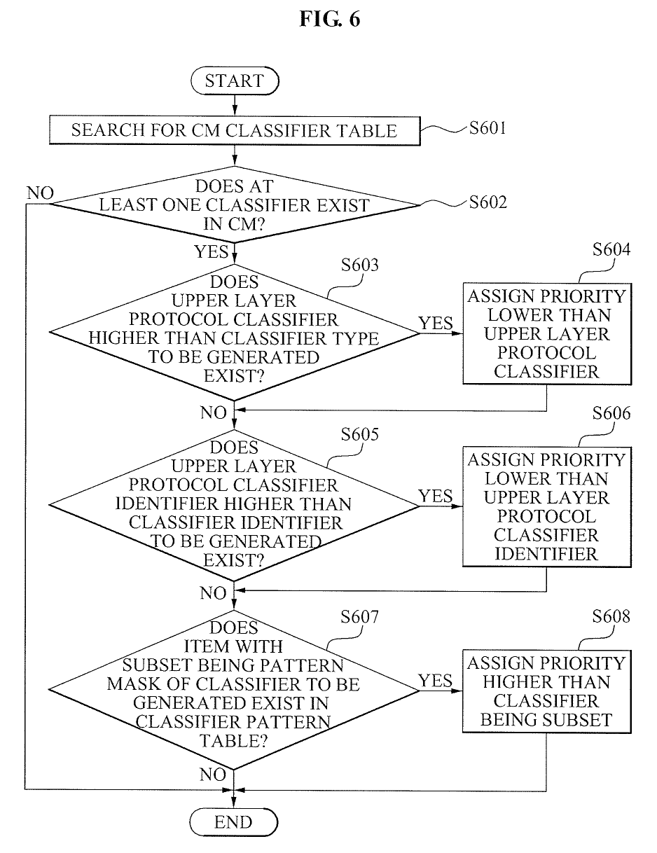

A method of determining the priority according to an exemplary embodiment of the present invention is illustrated in FIG. 6.

In operation S509, when the priority with respect to a service flow classifier is determined, the service flow controller 201 stores corresponding information in the CM classifier table 301 and the classifier pattern table 303.

In operation S510, the service flow controller 201 composes a matching pattern for service flow classification of a form illustrated in FIG. 3C. In operation S511, the service flow controller 201 stores the matching pattern used for a search word in an available space of the downstream service flow table 306, and downstream service flow information.

In operation S512, when the control request is different from the generation request for the service flow in operation S502, the service flow controller 201 determines whether the control request corresponds to a deletion request for the service flow. In operation S513, when the control request corresponds to the deletion request, the service flow controller 201 determines whether the CM requested in the CM classifier table is registered.

When the CM having transmitted the control request is the unregistered CM, the service flow controller 201 completes a service flow control process.

In operations S514 and S515, when the CM having transmitted the control request is the registered CM, the service flow controller 201 deletes the classifier with respect to the corresponding service flow from the CM classifier table and the classifier pattern table. In operation S516, the service flow controller 201 composes a matching pattern with respect to the service flow. In operation S517, the service flow controller 201 searches for corresponding service flow information from the downstream service flow table, and deletes corresponding information.

In operation S518, when the control request is different from the deletion request for the service flow, the service flow controller 201 determines whether the control request corresponds to a change request for the service flow. When the control request is different from the change request for the service flow, the service flow controller 201 completes the service flow control process.

In operations S514 through S517, when the control request corresponds to the change request for the service flow, the service flow controller 201 first performs a service flow deletion process. In operations S503 through S511, the service flow controller 201 performs a service flow generation process using the changed information.

As described above, first performing the service flow deletion process with respect to the change request for the service flow is for readjusting the priority with respect to the classifier pattern and resetting the service flow information into the changed information based on service flow change.

In operation S508, when at least one piece of the registered service flow information exists in the corresponding CM, the service flow controller 201 must determine the priority of determining the classifier standard required to be first applied when classifying the packet.

FIG. 6 is a flowchart illustrating a method of determining a priority of classifier information according to an exemplary embodiment of the present invention.

Referring to FIG. 6, when the classifier information corresponding to a CM MAC address is registered in a classifier table, the method registers the classifier information generated by the predetermined method of determining the priority.

In operation S601, the service flow controller 201 first searches for a CM classifier table. In operation S602, the service flow controller 201 determines whether registered service flow information exists in a corresponding CM.

In operation S603, when at least one classifier is registered, the service flow controller 201 determines whether an upper layer protocol classifier higher than a classifier type to be generated exists among registered classifiers.

In operation S604, when the upper layer protocol classifier exists, a priority lower than the upper layer protocol classifier is assigned to a classifier to be generated. When the upper layer protocol classifier does not exist, a high priority is assigned to the classifier to be generated.

In operation S605, when the same layer protocol classifier exists in operation S603, the method determines whether a classifier identifier with respect to an upper layer protocol exists among the registered classifiers. In operation S606, when the upper layer protocol classifier identifier exists, a priority lower than the upper layer protocol classifier identifier is assigned to a classifier identifier to be generated.

In operation S607, when there is a classifier of which protocol layers with respect to a type and an identifier are same, from among the registered classifiers, the method determines whether the classifier to be generated is a subset of the registered classifier.

In operation S608, since the service flow is overlapped when the classifier to be generated is the subset of the registered classifier, a high priority is assigned to the classifier to be generated, the classifier being included in the subset. When the classifier to be generated is not the subset, the same priority is assigned to the classifier and the classifier is sequentially stored in a subsequent storage location.

As described above, the high priority with respect to the classifier type and the identifier may be generally applied to the upper layer protocol, however, the priority may be randomly set by an operator and may be adjusted by presetting.

The method of controlling the downstream service flow according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, it is possible to quickly extract service flow classification information based on a classifier type and a QoS, compose a matching string including the classifier type and information, and control a downstream service flow so that downstream packets may be efficiently classified in a CMTS MAC layer.

Also, according to the present invention, it is possible to determine a classifier priority based on a priority of a protocol and overlapping in a classification pattern when generating a service flow, thereby eliminating ambiguity among classifiers applied when classifying the service flow.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of controlling a downstream service flow for a cable modem (CM), the method comprising:
receiving a control request with respect to a service flow;
generating classifier information for identifying a Quality of Service (QoS) classification standard of the service flow for which a generation request is performed, and registering the generated classifier information in a table when the control request is the generation request for the service flow;
registering a pattern mask corresponding to the classifier information in the table; and
composing the table for searching for downstream service flow information of a downstream input packet using the classifier information and the pattern mask.

2. The method of claim 1, wherein the classifier information includes type information about the service flow and identifier information.

3. The method of claim 1, wherein the pattern mask corresponds to information for setting a location necessary for classifying the service flow of the downstream input packet.

4. The method of claim 1, wherein the table for searching for the downstream service flow information of the downstream input packet is composed to enable a search for service flow information using, by a search scheme, the classifier information and pattern information extracted from both the pattern mask and the downstream input packet.

5. The method of claim 1, wherein the generating and registering of the classifier information determines whether the classifier information corresponding to a Media Access Control (MAC) address of the CM transmitting the control request with respect to the service flow is registered, and
registers the generated classifier information based on a predetermined priority determination method when the classifier information corresponding to the MAC address is registered.

6. The method of claim 5, wherein the predetermined priority determination method assigns a high priority to the classifier information with an tipper layer protocol for a classifier type of the classifier information.

7. The method of claim 5, wherein the predetermined priority determination method assigns a high priority to the classifier information with an upper layer protocol for an identifier of the classifier information.

8. The method of claim 5, wherein the predetermined priority determination method assigns a low priority to the classifier information being a subset of the generated classifier information and the registered classifier information.

9. The method of claim 1, further comprising:
when the control request is a service flow change request,
deleting the classifier information corresponding to the service flow change request in the table storing the classifier information;
deleting the pattern mask corresponding to the deleted classifier information;
deleting corresponding service flow information using the deleted classifier information and the deleted pattern mask; and
regenerating the service flow information based on the service flow change request.

10. An apparatus for controlling a downstream service flow for a CM, the apparatus comprising:
a service flow controller to control a service flow based on a control request with respect to the service flow;
a classifier table storage unit to register, via control of the service flow controller, classifier information for identifying a QoS classification standard of the service flow requested;
a classifier pattern table storage unit to store a pattern mask corresponding to the classifier information; and
a downstream service flow table storage unit to search for service flow information using the classifier information and the pattern mask.

11. The apparatus of claim 10, wherein the classifier information includes type information about the service flow and identifier information.

12. The apparatus of claim 10, wherein a classifier table registers the classifier information based on a predetermined priority.

13. The apparatus of claim 10, wherein the pattern mask corresponds to information for setting a location necessary for classifying the service flow of the downstream input packet.

14. The apparatus of claim 10, wherein a table for searching for downstream service flow information of a downstream input packet is composed to enable a search for service flow information using, by a search scheme, the classifier information and pattern information extracted from both the pattern mask and the downstream input packet.
